(19) United States
(12) Patent Application Publication
(10) Pub. No.: US 2024/0126608 A1
(43) Pub. Date: Apr. 18, 2024

(54) VALIDATION SYSTEM FOR EXECUTING A METHOD FOR PRIORITIZING VALIDATION TASKS

(71) Applicant: dSPACE GmbH, Paderbom (DE)

(72) Inventors: Thomas MISCH, Paderborn (DE); Simon GORDON, Paderborn (DE)

(73) Assignee: dSPACE GmbH, Paderborn (DE)

(21) Appl. No.: 18/380,378

(22) Filed: Oct. 16, 2023

(30) Foreign Application Priority Data
Oct. 17, 2022 (DE) 20 2022 105 829.6

(51) Int. Cl. G06F 9/50

(52) U.S. Cl. CPC G06F 9/5038

(57) ABSTRACT

A validation system for executing a method for prioritizing validation tasks, wherein the validation tasks are carried out by execution units of the validation system, wherein the execution units are divided into at least two groups and each group is assigned capabilities by the validation system and/or by a user of the validation system, so that execution units of a respective group have the capabilities of the group and, when the validation tasks are executed automatically by the validation system and/or by the user, a requirement of the respective validation task for the capability of the execution units and a priority for execution are specified and, taking into account the priorities and the capable execution units, an execution sequence is determined and the validation task is executed according to the execution sequence by the capable execution units.

This nonprovisional application claims priority under 35 U.S.C. § 119(a) to German Patent Application No. 20 2022 105 829.6, which was filed in Germany on Oct. 17, 2022, and which is herein incorporated by reference.

### BACKGROUND OF THE INVENTION

### Field of the Invention

The invention relates to a validation system for executing a method for prioritizing validation tasks.

### Description of the Background Art

Driving assistance systems such as, e.g., adaptive cruise control and/or functions for highly automated driving can be verified or validated using various verification methods. Simulations can be used in particular in this regard. In this context, a simulation includes a large number of validation tasks that must be performed in order to carry out the complete simulation. Here, the simulation and the associated validation tasks are performed by a validation system. In this regard, the validation system has various execution units that take over the execution of the validation tasks.

The effort, in particular the time and/or cost, for testing such vehicle functions using simulations is typically high, because a large number of potentially possible driving situations must be tested.

However, it is often necessary to be able to estimate how long and how expensive the execution will be, for example, to be able to schedule the test execution or to determine how many computing nodes and thus execution units that can perform the individual validation tasks need to be made available.

In addition, it is necessary to set a priority in the case of a high number of simulations and associated validation tasks.

Otherwise, a long-lasting simulation can possibly tie up too many execution units, so that other validation tasks that are urgently needed, however, cannot be executed.

Consequently, there is a need to improve existing test methods, especially for driver assistance systems, to the effect that a priority for validation tasks of a simulation of a test case is specified and the validation tasks are executed accordingly.

### SUMMARY OF THE INVENTION

It is therefore the object of the invention to provide a validation system for executing a method for prioritizing validation tasks.

The object is achieved by a validation system for executing a method for prioritizing validation tasks.

The validation system for executing a method for prioritizing validation tasks enables the grouping of execution units into at least two groups. Each group has different capabilities, which are determined by the validation system or a user. Accordingly, the execution units of the group also have these capabilities. An execution unit can also belong to a number of groups. Validation tasks, in contrast, have specific requirements for an execution unit. If it is a validation task to be executed in connection with a hardware-in-the-loop test procedure, thus, specific protocols and interfaces are needed as a requirement of the validation task during execution. Therefore, execution units are needed for execution that have these capabilities. The requirements of a validation task are set automatically by the validation system and/or by the user when the validation tasks are executed. In addition, a priority of the validation task is specified which determines an execution sequence. The execution sequence is dynamically defined in combination with the available capable execution units and the priority. The validation tasks are then executed according to the execution sequence.

The validation system can thereby be present in various examples. Thus, it can be a closed system or individual distributed components. In addition, the at least one component that forms the validation system or the component that maps the prioritization method can also reside in a cloud environment or, in a further preferred embodiment, be executed locally on, for example, an ESXi server. The subjects under test (SUT) to be validated can also be made available either in cloud environments or locally.

The purpose of the validation system is, for example, to test a device for the at least partial autonomous guidance of a transport vehicle and/or road user. Various test methods can be used here.

In particular, hardware-in-the-loop (HIL) methods, software-in-the-loop (SIL) methods, scenario-based testing, step-based testing, data replay testing, or a combination of test methods can be used. According to the invention, the test methods mentioned are not to be regarded as exhaustive.

The execution units can be divided into at least two groups. Each group of execution units has different capabilities. In this regard, an execution unit can be present in one or more groups. The assignment to groups is determined during system installation. However, before starting the validation system or before starting the execution of a validation task, the validation system or a user can determine how many and which execution units should be made available. By means of this mechanism, resources can be made available in a targeted manner, especially for specific application cases, and unnecessary resources are not consumed, because execution units that are started but not used nevertheless tie up the computing capacities of the validation system.

In this regard, the capabilities of an execution unit comprise a type of validation task, an execution location, and/or an execution duration. The type of validation task can be specified, for example, by a test method such as SIL testing or HIL testing. This defines the specific requirements of the validation task for an execution unit. For example, interfaces or protocols to be used may differ in this case.

In addition, one type of validation task can be the inclusion of the validation task in the continuous integration (CI) and continuous deployment (CD) pipelines. Prioritization of this type of validation task can be necessary to ensure reliable further development of the subject or system under test (SUT).

For automotive manufacturers and/or suppliers, building a functioning CI/CD pipeline is necessary to ensure continuous further development of their products. In this regard, continuous changes to the product/software, which maps an autonomous driving function, for example, should also be able to be continuously tested and supplied. This is the only way to enable rapid development cycles, which play a major role in agile development in particular. Thus, priority testing of validation tasks from a CI/CD pipeline can be necessary in order not to jeopardize the development process. Therefore, according to the invention, CI/CD pipeline validation tasks can be carried out in a prioritized manner using the validation system to execute a method for prioritizing validation tasks.

Depending on the application, a user of the validation system may also wish to have, for example, validation tasks that are to be performed on a HIL dealt with in a prioritized manner. By executing the validation task prioritization method, priorities can also be designated for tasks with a specific execution location.

Another frequent problem is that validation tasks that have a long execution time block that many other validation tasks and resources are needed to execute the other validation tasks. Depending on the application, the validation system and/or the user or operator of the validation system can preferentially provide computational resources for validation tasks with short or long execution times to the execution of the validation task prioritization procedure.

Before starting an execution of a validation task, the validation system automatically sets or the user sets the requirements of the validation task for the execution units. In addition, the validation system or user specifies a priority of the validation task. From the requirements and the set priority of the validation tasks, conclusions can be drawn about the needs of the execution units and the capabilities of the execution unit. So that even before starting the validation task, execution units can be started in the required groups in a needs-based and resource-saving manner. Otherwise, execution units can also be idle and consume no or hardly any resources in this state.

An execution sequence is determined by the priorities of the validation tasks. This execution sequence determines access rights to available capable execution units and computing resources available in the validation system.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic diagram of traffic scenarios relevant to the invention;

FIG. 2 shows a schematic view of the method of the invention for prioritizing validation tasks;

FIG. 3 shows a schematic diagram of an execution sequence of the invention;

FIG. 4 shows a schematic view of the relationships between the CI pipeline and the execution sequence of the invention; and

FIG. 5 shows exemplary groups of execution units.

### DETAILED DESCRIPTION

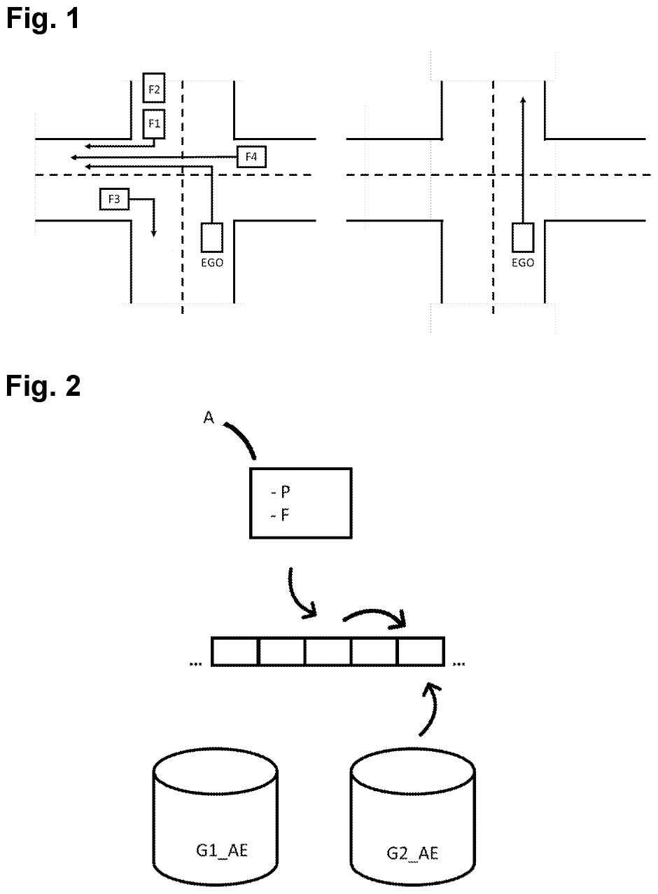

The illustration in FIG. 1 shows a schematic diagram of traffic scenarios relevant to the invention, which are used, for example, in a scenario-based test method. An intersection area is shown both in the traffic scene shown on the left and in the scene shown on the right side of the figure. In the left traffic scene, a left turn maneuver of an ego vehicle (EGO) is shown. In this case, four other fellow vehicles (F1-F4) are involved. In addition, the right traffic scene shows the crossing of the ego vehicle (EGO) without the participation of fellow vehicles. From this simple intersection area, various traffic situations can be derived that must be tested to ensure a driving function, especially an autonomous driving function. This results in a variety of validation tasks. But even in this test space with the corresponding number of validation tasks, prioritization of validation tasks becomes necessary in order to test efficiently. The method of the invention for prioritizing validation tasks, when executed in a validation system, enables an advantageous implementation of the prioritization of validation tasks.

The method of the invention for prioritizing validation tasks is shown in the illustration in FIG. 2. Here, validation tasks (A) are generated by concluding necessary tests of a driving function, for example, or necessary tests as part of a continuous integration of development advances. These validation tasks (A) have been assigned a requirement by the validation system and/or the user of the validation system, and thus a capability (F) required by the execution unit (AE) and a priority (P). The specified priority (P) determines the execution sequence of the validation tasks (A). The required capability (F) for the execution units (AE) determines the group (G1_AE or G2_AE) from which an execution unit (AE) is selected to execute the validation task (A). Two groups (G1_AE and G2_AE) are identified in the schematic diagram of the prioritization method. According to the invention, there can also be many more groups. In the example shown, the execution units (AE) that have the capability (F) required by the validation task (A) are combined into the group G2_AE.

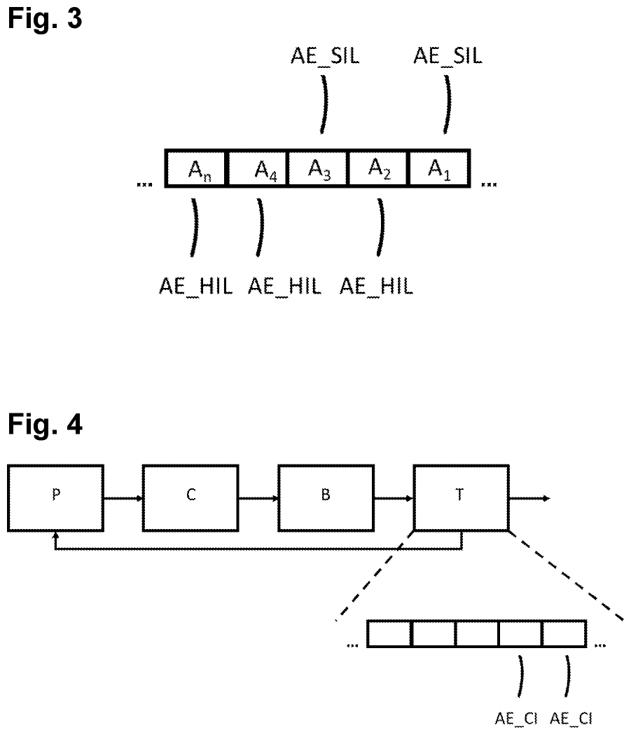

FIG. 3 shows a schematic diagram of an execution sequence of the invention. An execution sequence with validation tasks A₁-Aₙ was chosen for this example. The execution sequence shown was determined by the priorities set by the validation system or user.

In this case, validation tasks (A) that need a similar requirement for the capability of the execution units can be prioritized; however, it is possible to change the required capabilities just as in the embodiment shown.

Priorities and the assignment of required capabilities of validation tasks (A) and possible capabilities of execution units (AE) are combined by the prioritization method of the invention. A much more efficient test implementation can take place as a result, because bottlenecks in the required execution units (AE) are also identified. In the example given in FIG. 3, 3 execution units (AE_HIL) with the capability to carry out an execution on a hardware-in-the-loop (HIL) system can be seen. It is possible, for example, that only part of a test is performed virtually, but that in the end corresponding signals are sent to a real control unit. Not every execution unit (AE) of the validation system is set up for this. Thus, these execution units (AE) must be retained in particular for this type of validation tasks. Similarly, execution units (AE_SIL) can be set up to be able to efficiently execute only virtual tests in the context of a software-in-the-loop (SIL) application. The overall test execution can be optimized by knowing about the capabilities of the execution units (AE) and needs of the validation tasks (A). Finally, a significant time savings can be realized because validation tasks do not have to wait unscheduled for their execution and for available resources of the validation system.

Especially in the case of distributed development teams, the present invention can enable a better and more efficient collaboration between development teams. The teams may not know about the needs of the other teams or may not be able to prioritize due to lack of awareness. By the prioritization method of the invention, an optimal test procedure for all development teams is determined based on the specified priorities and the required capabilities and the requirements of the necessary validation tasks (A).

The illustration in FIG. 4 shows a schematic view of the relationships between the CI pipeline or CI/CD pipeline and the execution sequence of the invention.

For this purpose, the method steps of the CI pipeline are indicated first in the figure. Various embodiment variants for the CI/CD pipeline, which are intended to be covered according to the invention, can be determined from the literature. In this way, a phase of program creation or adaptation of the previous product can be identified in a simplified manner (build). The change made must then be tested accordingly (test) and unified with existing program structures (merge). The finished changes should then be supplied automatically and quickly/continuously to, for example, customers (release).

In FIG. 4, the process has been broadened once again and includes the method steps: planning (P), code, thus the creation of the program change (C), the compiling of the program (B), and finally the testing of the changes (T). A continuous cycle after the testing and a possibly necessary new planning is conceivable in this regard.

Especially in the testing phase, it is necessary to be able to use the resources of the validation system preferentially in order to be able to quickly and efficiently secure changes to the source code or a control unit, for example, for a driving function of autonomous driving. According to the method of the invention for prioritizing validation tasks, firstly, it is possible to set the priorities for validation tasks of the CI/CD pipeline high either automatically by the validation system or by the user. Furthermore, execution units (AE) can be provided exclusively for this type of validation tasks. This sets up a group with execution units (AE_CI) for validation tasks of the CI/CD pipeline. Thus, there can be no shortage of resources for these tasks.

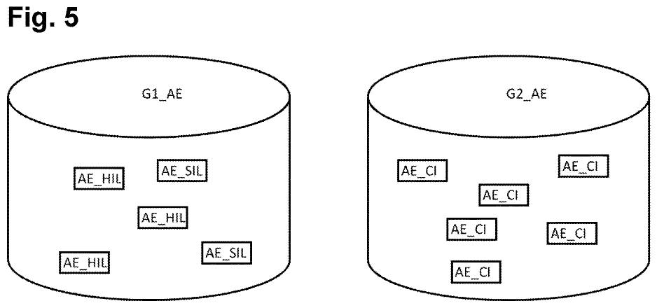

FIG. 5 shows exemplary groups of execution units. Execution units with the capability of being able to execute HIL and/or SIL validation tasks (HIL and SIL) have been grouped in the group G1_AE. Such a combination is possible, but according to the invention it can also be carried out in two individual groups. Here, the expected frequency of a specific type of validation tasks can influence the setup of groups of execution units. If the expected frequency of HIL validation tasks is high, more execution units with this capability must be assigned for this in order to ensure an optimal test execution.

In the G2 AE group, execution units (AE_CI) were provided specifically for validation tasks from the CI/CD pipeline. This can be of great importance in early development phases in particular, so that providing these execution units is necessary for the efficient development process. Execution units or groups of execution units can be dynamically activated or deactivated before starting an execution of a validation task in order to enable optimal resource utilization and not unnecessarily request resources that are not needed from execution units. Even without execution units actually taking over the execution of a validation task, costs and resources are consumed. Therefore, the method of the invention can contribute considerably to optimization.

The types of validation tasks presented are used as examples and should not be regarded as exhaustive.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A validation system for executing a method for prioritizing validation tasks, the system comprising:
execution units to perform validation tasks of the validation system, the execution units being divided into at least two groups and each group is assigned capabilities by the validation system and/or by a user of the validation system so that execution units of a respective group have the capabilities of the group and, when the validation tasks are executed automatically by the validation system and/or by the user, a requirement of the respective validation task for the capability of the execution units and a priority for execution are specified and, taking into account the priorities and the capable execution units, an execution sequence is determined and the validation task is executed according to the execution sequence by the capable execution units.

2. The validation system according to claim 1, wherein the validation system includes individual components and the execution of the prioritization method is carried out by a component of the validation system.

3. The validation system according to claim 1, wherein the validation tasks are suitable for testing a device for the at least partial autonomous guidance of a transport vehicle and/or road user.

4. The validation system according to claim 1, wherein the validation system and/or components of the validation system are executed locally or in a cloud environment.

5. The validation system according to claim 1, wherein the capabilities of the at least two groups of execution units comprise a type of validation task, an execution location of the validation task, and/or an execution duration of the validation task.

6. The validation system according to claim 1, wherein each execution unit belongs to at least one group and thus has at least one capability.

7. The validation system according to claim 1, wherein validation tasks with a higher priority and thus earlier in the execution sequence have priority access to computing resources and/or execution units of the validation system.

8. The validation system according to claim 1, wherein execution units are dynamically activated and/or deactivated before starting an execution of a validation task.

9. The validation system according to claim 1, wherein the priority of a validation task is dynamically adjusted before starting the execution of the validation task.

10. The validation system according to claim 1, wherein the requirements of a validation task are dynamically adjusted before starting the execution of the validation task.
